(19) United States
(12) Patent Application Publication
(10) Pub. No.: US 2008/0057353 A1
(43) Pub. Date: Mar. 6, 2008

(54) FUEL CELL SYSTEM HAVING ACTIVATION ASSIST APPARATUS AND METHOD

(76) Inventors: CHUN-CHIN TUNG, ChuPei (TW); Wen-Hsing Chang, Chupez (TW)

Correspondence Address: G. LINK CO., LTD., 3550 BELL ROAD, MINOOKA, IL, 60447, US

(21) Appl. No.: 11/849,273

(22) Filed: Sep. 1, 2007

(30) Foreign Application Priority Data
Sep. 4, 2006 (TW) 095132589

(51) Int. Cl. H01M 8/04

(52) U.S. Cl. 429/8; 429/13; 429/34

(57) ABSTRACT

The present invention relates to a fuel cell system having activation assist apparatus and method, wherein the method aims to provide an effective operating method for activating the fluid drawing device in the fuel cell system through external force. The external force acts to activate the fluid drawing device without going through the internal fuel cell. Another object of the activation method is to control the activation of fluid drawing device through an internal chargeable cell and a micro control unit. The activation method further detects and analyzes the status of fuel in the fuel cell through the micro control unit to determine whether to activate the fluid drawing device. In case the chargeable cell is unable to activate the micro control unit or fluid drawing device, it can be recharged and then activate the micro control unit or the fluid drawing device. The method coupled with the apparatus provided in the present invention can also effectively activate and operate the fluid drawing device in the fuel cell system in the presence or absence of a chargeable cell, wherein the fluid drawing device is directly or indirectly activated.

### FIELD OF THE INVENTION

The present invention relates to a fuel cell system having activation assist apparatus and method, more specifically, relates to a fuel supply method and apparatus in the fuel cell system, which effectively enable normal fuel supply in the fuel cell system.

### BACKGROUND OF THE INVENTION

Fuel cell is a power generating apparatus that is unlike a non-chargeable battery which is discarded after use, nor a rechargeable battery that needs to be recharged after use. Fuel cell, as the name indicates, needs to have fuel added in order to maintain its power, and the fuel is “hydrogen.” A fuel cell contains a cathode and an anode, which are respectively filled with electrolytes and have a permeable membrane therebetween. The hydrogen enters into the fuel cell from its anode, while oxygen (or air) enters the fuel cell from its cathode. There are a wide variety of fuel cells available, of which, proton exchange membrane fuel cell (PEMFC) and direct methanol fuel cell (DMFC) are micro systems that are portable and operable under room temperature, and offer the advantages of small size, light weight and convenient for stack design. The DMFC uses liquid methanol as fuel. Liquid methanol has energy density three to four times that of the same volume of liquid hydrogen, and its storage and transport are far more convenient and safer. Liquid methanol is also easy to obtain and low cost, hence better meeting the needs of portable electronic products.

The fuel for the fuel cell is stored in a fuel supply device and fed into the cell through a fluid drawing device, such as a pump, to enable the continuing operation of the fuel cell. In conventional technology, the activation of the fluid drawing device is powered by the fuel cell. Thus when the power of the fuel cell is below the minimum activation voltage of the pump, when there is no power, or when the primary fuel cell does not work, the fuel cell is unable to obtain fuel from the fuel supply device through the pump.

In view of the problem just discussed, the present invention aims to provide a fuel cell activation method and apparatus, which effectively addresses the unsolved problem in prior art.

### SUMMARY OF THE INVENTION

The present invention relates to a fuel cell system having activation assist apparatus and method, wherein the method aims to provide an effective operating method for activating the fluid drawing device in the fuel cell system through an external force. The external force acts to activate the fluid drawing device without going through the power of the internal fuel cell.

Another object of the present invention is to control the activation of fluid drawing device through an internal chargeable cell and a micro control unit (MCU). The activation method further detects the status of fuel inside the fuel cell through the micro control unit. The aforesaid detection is achieved through a sensor or sensing means. Subsequently the activation method analyzes the fuel use status and activates the fluid drawing device. The present invention further provides an apparatus that can charge the chargeable cell when the power of chargeable cell is unable to provide for the activation of the micro control unit or fluid drawing device, and enable the chargeable cell to activate the micro control unit or fluid drawing device.

Yet another object of the present invention is to couple the aforesaid method and apparatus that can effectively activate and operate the fluid drawing device in the fuel cell system in the presence or absence of a chargeable cell, wherein the fluid drawing device is activated directly or indirectly.

The fuel cell system according to the present invention comprises a fuel supply device, a fluid drawing device, an auxiliary fluid drawing device and a fuel cell body, wherein the fuel cell body is a direct methanol fuel cell (DMFC), in which methanol and oxygen undergo chemical reaction to generate thermodynamic potential via a specific method. Without the aid of moving parts, the DMFC generates electric current through electrochemical reaction without combustion or the need to store the fuel and convert it into hydrogen, or to expose the hydrogen to protein exchange membrane (PEM). The DMFC is superior to conventional battery at where the former can sustain the power generation by adding fuel alone. The DMFC is a generating equipment, while conventional battery is merely an energy storage equipment. The DMFC operates by adding fuel and continues to generate electric energy by providing sufficient fuel and oxygen without recharging. The fuel in a DMFC is stored in a fuel supply device, which feeds the fuel into the fuel cell via a fluid drawing device. The fluid drawing device is powered by the fuel cell body. However when the power supplied by the fuel cell is unable to provide for the operation of fluid drawing device, a method of activating the fluid drawing device using an external means is employed, so that the fuel solution in the fuel supply device can be fed into the fuel cell body. The external activation is achieved by pressing a button or manual push where sufficient power is generated to activate the fluid drawing device or fuel solution is pushed into the fuel cell body by manual means. With the fuel supply, the fuel cell body is able to generate sufficient power to reactivate the fluid drawing device, making it an effective activation method.

If the fuel cell system comprises a chargeable cell or a micro control unit or a combination thereof, the chargeable cell can provide the voltage and current needed for the activation of fluid drawing device when the fuel cell is unable to provide such power, and the micro control unit can analyze and determine whether to activate the fluid drawing device. In another embodiment, the chargeable cell can be recharged through an external auxiliary fluid drawing device, or through the operation of the fuel cell or a solar cell. After the recharge, the chargeable cell can activate the fluid drawing device. The activation method or apparatus of the present invention can effectively activate the fluid drawing device and enable the fuel cell system to operate normally.

### BRIEF DESCRIPTION OF THE DRAWINGS

FIG. 1 is a schematic diagram showing the fuel cell activation assist method according to the present invention;

FIG. 2 is a schematic diagram showing an activation assist method for fuel cell supply device according to the present invention; and

FIG. 3 is a schematic diagram showing another embodiment of fuel cell fluid supply assist method according to the present invention.

### DETAILED DESCRIPTION OF THE INVENTION

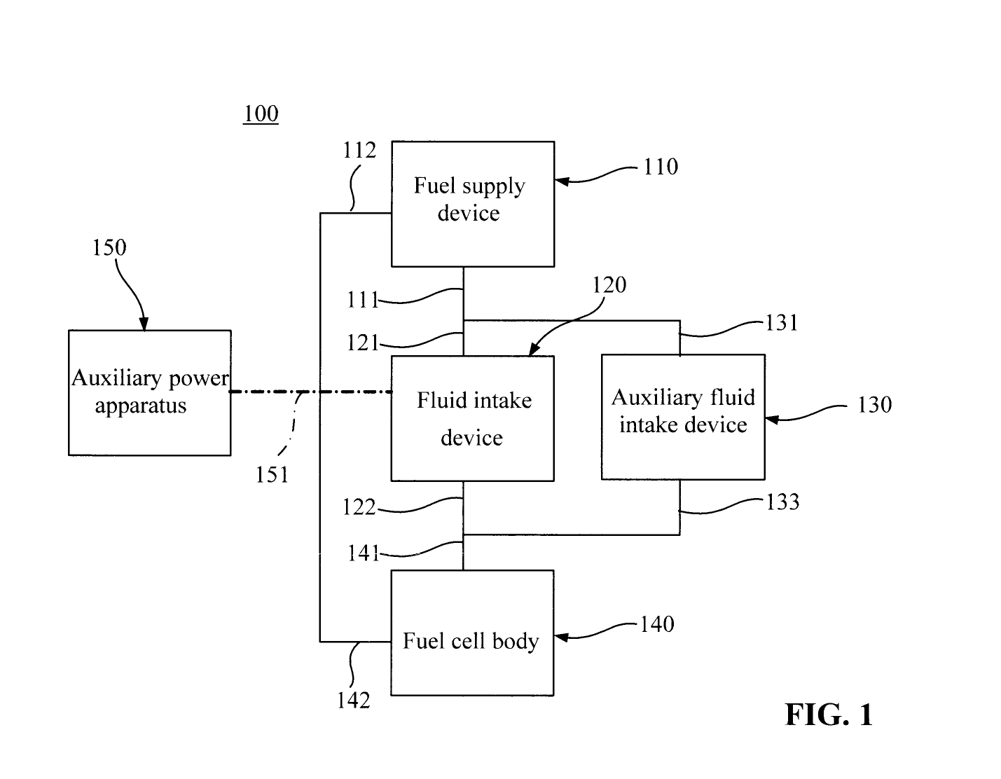

FIG. 1 is a schematic diagram 100 showing the fuel cell activation assist method according to the present invention, which comprises several main components, including a fuel supply device 110, a fluid drawing device 120, an auxiliary fluid drawing device 130, a fuel cell body 140, and an auxiliary power apparatus 150. It also comprises fluid channels allowing the solution to flow therein. That is, the fuel solution is transported from the fuel supply device 110 to the fuel cell body 140 via the fluid channel. The auxiliary fluid drawing device 130 is a fluid intake mechanism which is operated by external force or manual means that pushes the fuel solution into the fuel cell body 140 without the use of electric power.

The main components are connected in a manner described below. That is, the fuel supply device 110 is connected to the auxiliary fluid drawing device channel 131 and fluid drawing device channel 121 via a channel 111, and the auxiliary fluid drawing device 130 is connected to fluid channel 131, and connected to fuel cell body 140 via other fluid channels 133 and 141 to form a fuel supply path. There are also circulation channels 112 and 142 to allow residual fuel solution in the fuel cell body 140 to circulate back to fuel supply device 110 through the circulation channels 112 and 142, and allow high-concentration fuel solution contained in an external fuel replenishing cartridge to be fed into the fuel supply device 110 in view of the concentration of the residual fuel solution. The fuel supply device 110 can also be called a mixing chamber with the same function.

The fuel cell activation assist method according to the present invention allows fuel solution in the fuel supply device 110 to be fed into the fuel cell body 140 to keep the fuel cell system operating. Under normal operation, the fuel solution in the fuel supply device 110 is fed into the fuel cell body 140 via the working of the fluid drawing device 120. At this time, the fluid drawing device 120 is powered by the power generated from the fuel cell body. However when the fuel cell system is initiated or when the fuel concentration in the fuel cell body is inadequate to generate sufficient power for the fuel supply device to enable the operation of fluid drawing device, the present invention provides an auxiliary fluid drawing device 130. Such device 130 has a mechanical construction where solution in the fuel supply device 110 is flown via channels 111, 131 into the auxiliary fluid drawing device 130, and from where fed into fuel cell body 140 via channels 133 and 141 with the aid of external force. The fuel solution fed into the fuel cell body 140 will cause electrochemical reaction in the fuel cell to generate power. The power generated thereof will then activate the fluid drawing device 120 to restore the original fuel supply mode. In another embodiment, the fuel solution in the fuel supply device 110 is fed into the fuel cell body 140 via the fuel channel by manual means, for example, by turning a handle or pushing.

The auxiliary power apparatus 150 can be used to drive the fluid drawing device 120 directly by providing power needed by the fluid drawing device 120. That is, the auxiliary power apparatus 150 directly drives the fluid drawing device 120 through electric cable 131 to supply fuel to fuel cell body 140 when the fluid drawing device cannot be activated. The auxiliary power apparatus 150 can be a manually powered apparatus or a solar cell.

The auxiliary fluid drawing device 130 and the auxiliary power apparatus 150 can stand alone or exist in an assembly. Their purpose is to make sure the fuel solution in fuel supply device 110 is continuously supplied to the fuel cell to sustain the electrochemical reaction when the fluid drawing device 120 does not operate.

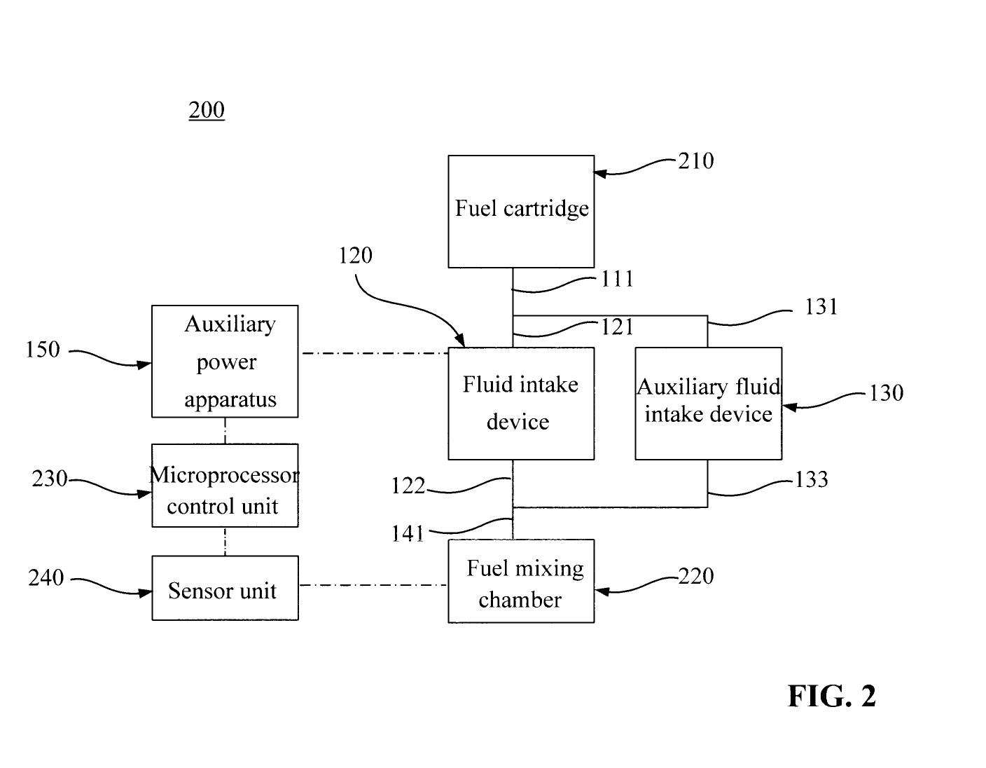

FIG. 2 is a schematic diagram 200 showing an activation assist method for fuel cell supply device, which comprises several main components, including a fuel cartridge 210, a fluid drawing device 120, an auxiliary fluid drawing device 130, a fuel mixing chamber 220, an auxiliary power apparatus 150, a microprocessor control unit 230, and a sensor unit 240. It also comprises fluid channels and electric cables having the same purpose as specified in FIG. 1. The electric cable is the transfer medium between power source and control signal.

The main components are connected in a manner described below. That is, the fuel cartridge 210 is connected to the auxiliary fluid drawing device channel 131 and fluid drawing device channel 121 via a channel 111, and the auxiliary fluid drawing device 130 is connected to fluid channel 131, and connected to fuel mixing chamber 220 via other fluid channels 133 and 141 to form a fuel supply path. The auxiliary power apparatus 150 is connected to the microprocessor control unit 230 and the sensor unit 240.

The high-concentration fuel solution in the external fuel replenishing cartridge is fed into the fuel mixing chamber 220, wherein the replenishing is determined by the fuel concentration in the fuel mixing chamber 220 as detected by the sensor unit 240 and analyzed by the microprocessor control unit 230.

The activation assist method according to the present invention can be used in the fuel supply device 110. It can also be used in the adjustment of fuel concentration in fuel mixing chamber 220. The auxiliary apparatus can stand alone or exist in an assembly, or the same auxiliary apparatus can be used through switching.

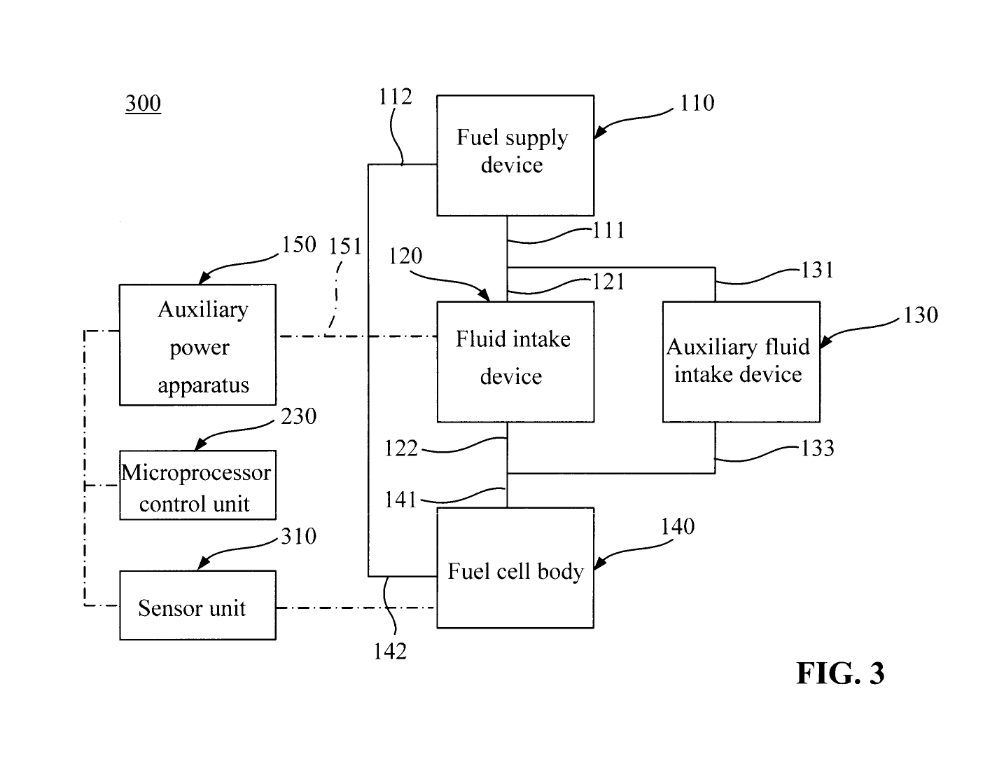

FIG. 3 is a schematic diagram 300 showing another embodiment of the fuel cell fluid supply assist method, which comprises several main components, including a fuel supply device 110, a fluid drawing device 120, an auxiliary fluid drawing device 130, a fuel cell body 140, an auxiliary power apparatus 150, a microprocessor control unit 230, and a chargeable cell 310.

The main components are connected in a manner described below. That is, the fuel supply device 110 is connected to the auxiliary fluid drawing device channel 131 via a channel, and the auxiliary fluid drawing device 130 is connected to the fuel cell body 140 via channel 133. The fuel cell body 140 is connected to the chargeable cell 310 via an electric cable and to the microprocessor control unit 230 via another electric cable. The auxiliary power apparatus 150 is connected to the microprocessor control unit 230 and the chargeable cell 310 via electric cables.

The purpose of the auxiliary power apparatus 150 is to charge the chargeable cell 310 so that the chargeable cell 310 can power the fluid drawing device 120 to supply the fuel cell body 140 with fuel without going through the auxiliary fluid drawing device 130 which relies on external force to operate. With the fuel supply, the fuel cell body 140 charges the chargeable cell 310 to activate the fluid drawing device 120. The auxiliary power apparatus 150 can use a solar cell to store power in the chargeable cell 310 to achieve the charging of chargeable cell 310, thereby activating the microprocessor control unit 230 or fluid drawing device 120. The power of chargeable cell 310 can also be supplied using a manual power generator, which generates power by turning under the exertion of force, or through induction coils, or through other manual means. In addition, the manual power generator can be coupled with a solar cell to serve as the auxiliary power apparatus 150.

What is claimed is:

1. An activation assist method for fuel cell system, comprising the steps of:
providing a fuel supply device, a fluid channel, a fluid drawing device, an auxiliary fluid drawing device, and a fuel cell body;
the fuel supply device supplying fuel therein and delivery the fuel through the fluid channel;
the auxiliary fluid drawing device driving the fuel in the fluid channel via externally supplied power and enabling the fuel in fluid channel to flow to the fuel cell body;
stopping the action of auxiliary fluid drawing device; and
the fuel cell body generating power to supply the fluid drawing device, enabling the fluid drawing device to drive the fuel in the fluid channel and moving the fuel in the fluid channel to the fuel cell body.

2. The activation assist method for fuel cell system according to claim 1, wherein the auxiliary fluid drawing device is a hand-push intake device.

3. The activation assist method for fuel cell system according to claim 1, wherein the auxiliary fluid drawing device is a hand-rolling intake device.

4. The activation assist method for fuel cell system according to claim 1, wherein the auxiliary fluid drawing device is a mechanical intake device.

5. The activation assist method for fuel cell system according to claim 1, further comprising a power assist method to supply power to said fluid drawing device, a chargeable cell and a microprocessor unit directly.

6. An auxiliary fuel cell fluid intake apparatus for use in a fuel cell that can undergo electrochemical reaction and generate power, comprising:
a fuel supply device;
a fluid drawing device having a fluid intake mechanism to convert electric power into motive power to drive fluid fuel and feed the fuel into the fuel cell; and
an auxiliary fluid drawing device having another fluid intake mechanism to convert externally supplied power into motive power to drive the fluid fuel and feed the fuel into the fuel cell;
wherein the fuel supply device is respectively connected to the fluid drawing device and the auxiliary fluid drawing device, the fluid drawing device and the auxiliary fluid drawing device being respectively connected to the fuel cell.

7. The auxiliary fuel cell fluid intake apparatus according to claim 6, further comprising an auxiliary power apparatus, the auxiliary power apparatus being electrically connected to the fluid drawing device to supply power for driving the fluid intake mechanism of the fluid drawing device.

8. The auxiliary fuel cell fluid intake apparatus according to claim 7, wherein the auxiliary power apparatus is a hand powered generator.

9. The auxiliary fuel cell fluid intake apparatus according to claim 7, wherein the auxiliary power apparatus is a solar cell.

10. The auxiliary fuel cell fluid intake apparatus according to claim 6, further comprising a chargeable cell, the chargeable cell being electrically connected to the fluid drawing device to supply power for driving the fluid intake mechanism of the fluid drawing device.

11. The auxiliary fuel cell fluid intake apparatus according to claim 10, wherein the chargeable cell is electrically connected to the auxiliary power apparatus, the auxiliary power apparatus being able to supply power to the chargeable cell for charging the chargeable cell.

12. The auxiliary fuel cell fluid intake apparatus according to claim 11, wherein the auxiliary power apparatus is a hand powered generator.

13. The auxiliary fuel cell fluid intake apparatus according to claim 11, wherein the auxiliary power apparatus is a solar cell.

14. An auxiliary fuel cell fluid intake apparatus for use in a fuel cell that can undergo electrochemical reaction and generate power, comprising:
a fuel supply device;
a fluid drawing device having a fluid intake mechanism to convert electric power into motive power to drive fluid fuel and feed the fuel into the fuel cell; and
an auxiliary power apparatus being a power generation apparatus that supplies power generated to the fluid drawing device and convert the power into motive power to drive the fluid fuel and feed the fuel into the fuel cell;
wherein the fuel supply device is connected to the fluid drawing device and the fluid drawing device is connected to the fuel cell, the auxiliary power apparatus being electrically connected to the fluid drawing device to supply power for driving the fluid intake mechanism of the fluid drawing device.

15. The auxiliary fuel cell fluid intake apparatus according to claim 14, wherein the auxiliary power apparatus is a hand powered generator.

16. The auxiliary fuel cell fluid intake apparatus according to claim 14, wherein the auxiliary power apparatus is a solar cell.

17. The auxiliary fuel cell fluid intake apparatus according to claim 14, further comprising a chargeable cell, the chargeable cell being electrically connected to the fluid drawing device to supply power for driving the fluid intake mechanism of the fluid drawing device.

18. The auxiliary fuel cell fluid intake apparatus according to claim 17, wherein the chargeable cell is electrically connected to the auxiliary power apparatus, the auxiliary power apparatus being able to supply power to the chargeable cell for charging the chargeable cell.

19. The auxiliary fuel cell fluid intake apparatus according to claim 18, wherein the auxiliary power apparatus is a hand powered generator.

20. The auxiliary fuel cell fluid intake apparatus according to claim 18, wherein the auxiliary power apparatus is a solar cell.

21. The auxiliary fuel cell fluid intake apparatus according to claim 17, further comprising a microprocessor control unit for detecting or analyzing the fuel status inside the fuel cell.

22. The auxiliary fuel cell fluid intake apparatus according to claim 21, wherein the microprocessor control unit is coupled with a sensor for detecting or analyzing the fuel status inside the fuel cell.

23. The auxiliary fuel cell fluid intake apparatus according to claim 21, wherein the microprocessor control unit is used to select either the on or off state of the fluid drawing device.

24. The auxiliary fuel cell fluid intake apparatus according to claim 21, wherein the microprocessor control unit is powered by a chargeable cell.
